(19) United States
(12) Patent Application Publication
(10) Pub. No.: US 2008/0059469 A1
(43) Pub. Date: Mar. 6, 2008

(54) Replication Token Based Synchronization

(75) Inventor: Clarence Madison Pruet, Flower Mound, TX (US)

Correspondence Address: INTERNATIONAL BUSINESS MACHINES CORP., IP LAW, 555 BAILEY AVENUE, J46/G4, SAN JOSE, CA, 95141, US

(73) Assignee: INTERNATIONAL BUSINESS MACHINES CORPORATION, Armonk, NY (US)

(21) Appl. No.: 11/469,257

(22) Filed: Aug. 31, 2006

(51) Int. Cl. G06F 17/30

(52) U.S. Cl. 707/8

(57) ABSTRACT

A method, system and computer program product that synchronize a table are provided. The rows of a source table of a database are scanned. The source table comprises a plurality of rows. The rows that are scanned are locked with at least one lock. At least one scan block comprising at least one row of the rows of the source table is formed. At least one token that is associated with the at least one scan block, respectively, is placed in a log. At least one lock that is associated with the at least one row that is associated with the at least one token is released. In response to encountering one token of the at least one token in the log, the at least one row of the scan block that is associated with the one token are placed in a replication conduit.

### CROSS-REFERENCE TO RELATED APPLICATIONS

Co-pending U.S. application Ser. No. 11/060,924 entitled “Online Repair of a Replicated Table,” filed on Feb. 18, 2005, by Rajesh Govind Naicken, Clarence Madison Pruet III, and Konduru Israel Rajakumar, assigned to International Business Machines Corporation (IBM) Docket No. SVL920040060US1, assigned to the assignee of the present invention, is incorporated herein by reference in its entirety.

### BACKGROUND OF THE INVENTION

1.0 Field of the Invention

This invention relates to a database management system; and in particular, this invention relates to replication token based synchronization.

2.0 Description of the Related Art

Database management systems allow large volumes of data to be stored and accessed efficiently and conveniently in a computer system. In various database management systems, data is stored in database tables which organize the data into rows and columns. FIG. 1 depicts an exemplary database table 20 which has rows 22 and columns 24. To more quickly access the data in a database table, an index may be generated based on one or more specified columns of the database table. In relational database management systems, specified columns are used to associate tables with each other.

The database management system responds to user commands to store and access data. The commands are typically Structured Query Language (SQL) statements such as SELECT, INSERT, UPDATE and DELETE, to select, insert, update and delete, respectively, the data in the rows and columns. The SQL statements typically conform to a SQL standard as published by the American National Standards Institute (ANSI) or the International Standards Organization (ISO).

An enterprise may have multiple database management systems, typically at different sites, and want to share data among the database management systems. A technique called replication is used to share data among multiple database management systems.

A replication system manages multiple copies of data at one or more sites, which allows the data to be shared among database management systems. Data may be replicated synchronously or asynchronously. In synchronous data replication, typically all hardware components and networks in the replication system must be available at all times.

Asynchronous data replication allows data to be replicated on a limited basis, and thus allows for system and network failures. In one type of asynchronous replication system, referred to as primary-target, all database changes originate at a primary database and are replicated to target databases. In another type of replication system, referred to as update-anywhere, updates to each database are applied at all other databases of the replication system.

An insert, update or delete to the tables of a database is a transactional event. A transaction comprises one or more transactional events that are treated as a unit. A commit is another type of transactional event which indicates the end of a transaction and causes the database to be changed in accordance with any inserts, updates or deletes associated with the transaction.

In some database management systems, a log writer updates a log as transactional events occur. Each transactional event is associated with an entry or record in the log; and each entry in the log is associated with a value representing its log position.

When a replication system is used, a user typically specifies the types of transactional events which cause data to be replicated. In addition, the user typically specifies the data which will be replicated, such as certain columns or an entire row. In some embodiments, the log writer of the database management system marks certain transactional events for replication in accordance with the specified types of transactional events. The replication system reads the log, retrieves the marked transactional events, and transmits the transactional events to one or more specified target servers. The target server applies the transactional events to the replicated table(s) on the target server.

A table at one database management system may be replicated to tables at other database management systems. A table may need to be synchronized to another table under some circumstances. A table may need to be synchronized if it is taken out of replication for some duration of time, if some of the rows of that table failed to be replicated due to errors, or if the table is newly added into the replication topology and a user wants to bring the table up-to-date.

Various database management systems operate in a non-stop environment in which the client applications using the database management system cannot be shut down. Thus, there is a need for a technique to synchronize a table without causing downtime to the client applications in the replication environment. The technique should synchronize the table without requiring replication to be stopped.

### SUMMARY OF THE INVENTION

To overcome the limitations in the prior art described above, and to overcome other limitations that will become apparent upon reading and understanding the present specification, various embodiments of a method, data processing system and computer program product that synchronize a table are provided. The rows of a source table of a database are scanned. The source table comprises a plurality of rows. The rows that are scanned are locked with at least one lock. At least one scan block comprising at least one row of the rows of the source table is formed. At least one token that is associated with the at least one scan block, respectively, is placed in a log. At least one lock that is associated with the at least one row that is associated with the at least one token is released. In response to encountering one token of the at least one token in the log, the at least one row of the scan block that is associated with the one token are placed in a replication conduit.

In this way, a table can be synchronized online without causing downtime to client applications and without stopping replication.

### BRIEF DESCRIPTION OF THE DRAWINGS

The teachings of the present invention can be readily understood by considering the following description in conjunction with the accompanying drawings, in which:

FIG. 1 depicts a block diagram of an illustrative table of a database management system;

FIG. 2 depicts a diagram of a replication environment suitable for use with the present invention;

FIG. 3 depicts a diagram of an embodiment of a scan block;

FIG. 4 depicts a diagram of an embodiment of a scan block identifier of the scan block of FIG. 3;

FIG. 5 depicts a diagram illustrating the operation of an embodiment of the present invention;

FIG. 6 depicts a flowchart of an embodiment of a scanner;

FIG. 7 depicts a flowchart of an embodiment of a snooper;

FIG. 8 depicts a flowchart of an embodiment of an apply component;

FIG. 9 depicts a flowchart of an embodiment of determining the total number of scan buffers;

FIG. 10 comprises FIGS. 10A and 10B which collectively depict a flowchart of another embodiment of a scanner; and

FIG. 11 depicts an illustrative data processing system which uses various embodiments of the present invention.

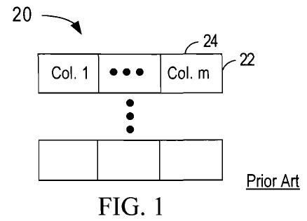

To facilitate understanding, identical reference numerals have been used, where possible, to designate identical elements that are common to some of the figures.

### DETAILED DESCRIPTION

After considering the following description, those skilled in the art will clearly realize that the teachings of the various embodiments of the present invention can be utilized to synchronize a replicated table. A computer-implemented method, data processing system and computer program product that synchronize a table are provided. The rows of a source table of a database are scanned. The source table comprises a plurality of rows. The rows that are scanned are locked with at least one lock. At least one scan block comprising at least one row of the rows of the source table is formed. At least one token that is associated with the at least one scan block, respectively, is placed in a log. At least one lock that is associated with the at least one row that is associated with the at least one token is released. In response to encountering one token of the at least one token in the log, the at least one row of the scan block that is associated with the one token are placed in a replication conduit.

A database server is a software application which implements a database management system. A replication server is a database server that participates in data replication. Multiple database servers can execute on the same physical server computer, and each database server can participate in replication. A database or replication server that participates in a replicate may also be referred to as a node.

In replication, changes to one or more tables of a database on a source replication server are collected, transported and applied to one or more corresponding tables on replication target servers. A replication application implements the replication server functionality.

To replicate data, a user defines a replicate. A replicate is associated with one or more replication servers, also referred to as participants, a table to replicate among the participants, and the columns of the table that are to be replicated. The replicate is also associated with various attributes which describe how to replicate the data among the participants, such as conflict resolution rules.

The replication server maintains replication information in a replicate definition that comprises one or more tables in a global catalog. The replicate definition comprises information specifying the replicate configuration and environment, information specifying what data is to be replicated, for example, whether to replicate particular columns or an entire row, and information specifying the conditions under which the data should be replicated. The replicate definition also specifies various attributes of the replicate such as a description of how to handle any conflicts during replication. For example, the replicate definition comprises a replicate identifier, the name of the replicate, the table(s) of the replicate, the columns to replicate, the SQL select statement which created the replicate, and various flags. The replicate definition also comprises identifiers, such as the names, of the participants of the replicate.

Each replication server typically has its own local copy of the global catalog and maintains one or more tables in the global catalog to keep track of the replicate definition and state.

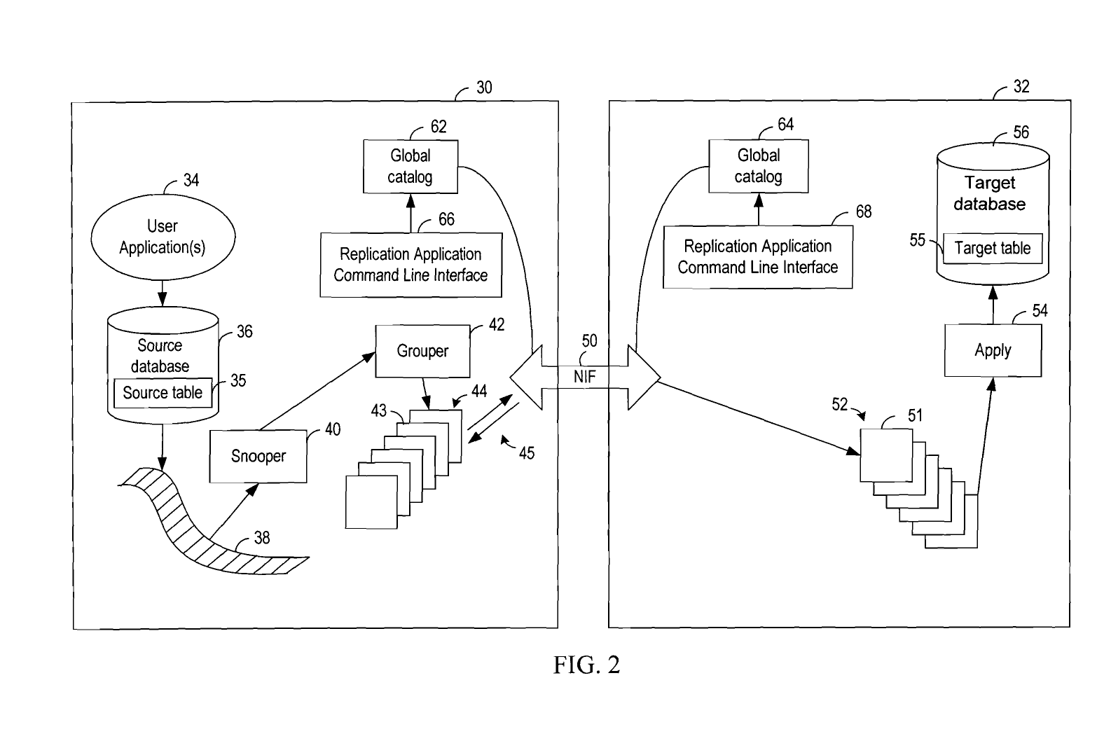

FIG. 2 depicts a diagram of an embodiment of replication servers suitable for use with the present invention. A source replication server 30 and a target replication server 32 are participants, or nodes, in a replicate. The source replication server 30 and the target replication server 32 will be referred to as a source server and a target server. The source server 30 and the target server typically execute on different computer systems. At the source server 30, one or more user applications (User Application(s) 34) are accessing and changing the tables, for example, source table (Source table) 35, of a source database (Source database) 36. The changes to the tables comprise inserting, updating and deleting one or more rows of the tables. The changes to the source database 36 are stored in a log 38. The changes to the data are transactional events. The log 38 represents the state of the rows of the table(s) as of particular times. The replication application comprises a snooper (Snooper) 40 and a grouper (Grouper) 42. The snooper 40 reads the log 38 and captures transactional events in accordance with the replicate definition. The grouper 42 assembles the captured transactional events in accordance with their associated transactions to provide transaction replication data 43 and places the transaction replication data 43 in a queue 44 to send to the target server 32 via the network interface (NIF) 50. In this description, the transaction replication data is also referred to as replication data or replicated data. As indicated by arrows 45, the queue 44 can be used to send and receive data. The queue 44 comprises a send queue to send data to the target server 32, and a receive queue to receive data from the target server 32.

At the target server 32, the transaction replication data 51 is received in a queue 52. An apply component (Apply) 54 retrieves the transaction replication data 51 from the queue 52 and applies the replication data 51 to the appropriate table, for example, target table (Target table) 55, and column(s) in the database 56. For example, if the transaction replication data comprises an insert operation, the apply component performs the insert operation on the target table of the replicate.

The source and target servers, 30 and 32, have global catalogs (Global catalog), 62 and 64, and a replication application command line interface (Replication Application Command Line Interface), 66 and 68, respectively. The replication application command line interface 66 and 68 receives commands for the replication application, and processes those commands. In various embodiments, the replication application command line interface 66 and 68 executes and/or invokes various software modules to execute the commands. The replication application command line interface 66 and 68 is also used to update the global catalogs 62 and 64, respectively.

In various embodiments, the replication application on a replication server typically comprises a snooper, a grouper and an apply component. In this way, data can be replicated both to and from the replication server.

In some embodiments, a computer system executing the replication application comprises multiple central processing units or processors, and various portions of the replication operation are executed concurrently. For example, a software module may execute on one or more processors and each portion of that software module that is executing on one or more processors is referred to as a thread.

In various embodiments, the term “replication conduit” refers to one or more data structures and executable modules which propagate the replication data from the log to at least one target server. The replication conduit is typically an ordered path from the log at the source server to at least one target server. In some embodiments, the replication conduit comprises the snooper, grouper, and queue at the source server, the network, and the apply component at the target server. To support database constructs such as referential integrity and transaction scope, a proper order of the replicated data changes is maintained in the replication conduit. The transactional events in the log are ordered in the same order as the original operations in the database, and the replication conduit maintains that same order.

In various embodiments, the replication application command line interface receives and processes various synchronization commands to synchronize a target table to a source table. In some embodiments, the following synchronization command is used to synchronize a single target table at a target server called servb to a single source table at a target server called serva of a specified replicate:

cdr sync replicate --repl=<replicate_name> --master=serva servb

In the command above, the “--repl=” parameter is used to specify the replicate name, the “--master=” parameter is used to specify the source server, and the specified target server name follows the name of the source server.

In some embodiments, a plurality of target tables at a plurality of specified target servers, respectively, are synchronized to a source table at a specified source server. The following command is used to synchronize a target table at target servers called servb, servc and servd to a source table at a source server called serva of a specified replicate:

cdr sync replicate --repl=<replicate_name> --master=serva servb servc servd

In various embodiments, a replicate and a source server of the replicate are specified, and the tables at the other participants of the replicate are synchronized to the table at the specified source server. In some embodiments, the following command is used to specify a replicate, called replicate_name, and source server called serva to which the other participants of the replicate are to be synchronized:

cdr sync replicate -repl=<replicate_name> --master=serva -all

In some embodiments, a replicate set is synchronized. The replicate set can be used to specify a plurality of replicates. For example, a replicate set called set1 has replicates repl1, repl2, repl3, and repl4. The following command may used to synchronize tables at a target server called servb to tables at the source server, called serva, of the replicate set called “set1” as follows:

cdr sync replset --set=set1 --master=serva servb

The “-set=” parameter specifies the name of the replicate set.

In some embodiments, tables at multiple target servers of a replicate set are synchronized. The following command may be used to synchronize target tables at target servers called servb, servc and servd to the source tables at the source server, called serva, of the replicate set called “set1” as follows:

cdr sync replset --set=set1 --master=serva servb servc servd

In various embodiments, a source server of a replicate set is specified and the target tables of all other participants of the replicate set are synchronized to the tables at the source server, using the following command:

cdr sync replset --set=set1 --master=serva --all

The commands described above are used within the replication application. Alternately, the commands to synchronize tables may be used outside of the replication application.

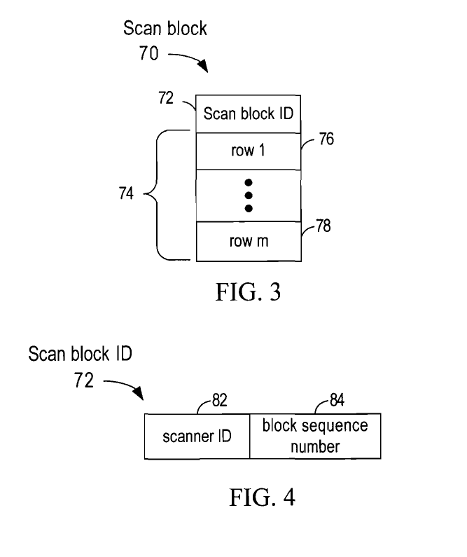

FIG. 3 depicts an illustrative scan block (Scan block) 70. The scan block 70 is a data structure, and not a database table. The scan block 70 comprises a Scan block identifier (ID) 72 and an array 74 of row buffers 76 through 78. The array of row buffers 74 is used to store rows from a source table. The rows of the scan block will eventually be placed into the replication conduit as a single transaction.

A scan block typically stores a predetermined number of rows. In various embodiments, the number of rows of the scan block is determined and set to increase parallelism as the scan blocks are processed at the target server.

FIG. 4 depicts an illustrative Scan block ID 72 of FIG. 3. The Scan block ID 72 has a scanner ID 82 and a block sequence number 84. The scanner ID 82 has a distinct value which identifies a scanner, for example, a scan thread, that placed the rows in the scan block. The block sequence number 84 has a value that identifies the sequence of the scan blocks as they are filled by the scanner that is associated with the scanner ID 82. For example, after invoking the scanner to synchronize a table, the first scan block filled by the scanner has a block sequence number 84 with a value of one. More generally the i^{th} scan block filled with rows of a source table by the scanner has a block sequence number 84 with a value of i.

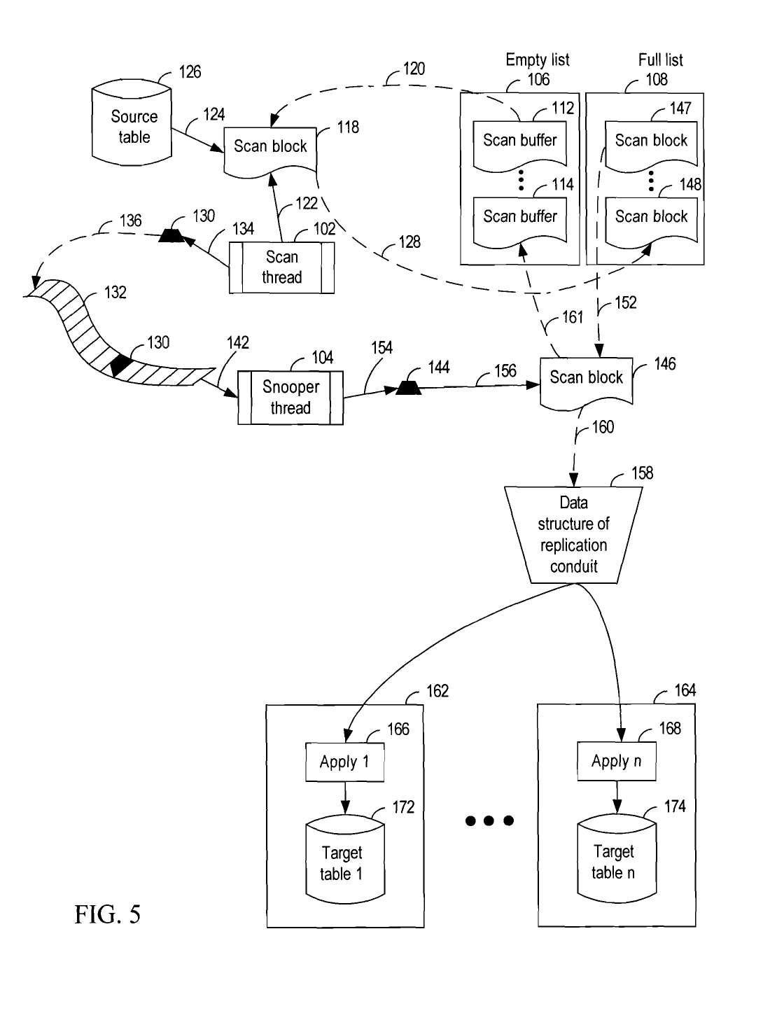

FIG. 5 depicts a diagram illustrating an embodiment of the present invention. A scanner places row data from a source table in scan blocks, and that row data is used to synchronize at least one target table to the source table. In this embodiment, a scanner and the snooper are implemented as threads, referred to as a Scan thread 102 and Snooper thread 104, respectively. However, the scanner and snooper are not meant to be limited to being implemented as threads; in other embodiments, other implementations may be used.

Flow control between the Scan thread 102 and the Snooper thread 104 is performed using an empty list (Empty list) 106 and a full list (Full list) 108. A plurality of scan buffers 112 through 114 are initially placed on the empty list 106 and the Scan thread 102 is created. The scan buffers 112 through 114 are used to store scan blocks, respectively. Initially the full list does not have any scan blocks. In this example, the full list 108 has a plurality of scan blocks, 147 to 148.

The Scan thread 102 retrieves a scan buffer for use as a scan block 118 from the empty list 106 as indicated by arrow 120. As indicated by arrows 122 and 124, the Scan thread 102 fills the scan block 118 as it reads rows from the source table 126. When the scan block 118 is full of rows, the Scan thread 102 places the scan block 118 on the full list 108, as indicated by arrow 128. The Scan thread 102 also places a token 130 into the log 132, as indicated by arrows 134 and 136. Each token in the log is associated with a particular scan block in the full list 108. The Scan thread 102 issues a commit. The Scan thread 102 retrieves another scan buffer from the empty list 106 and the process continues until the entire source table 126 is read.

The snooper thread 104 reads the log 132, as indicated by arrow 142. In this embodiment, in response to the snooper thread 104 encountering a token 144 in the log 132, the snooper thread 104 obtains the scan block 146 which is associated with the token from the full list 108, as indicated by arrows 152, 154 and 156. The Snooper thread 104 places the rows of the scan block 146 into one of the data structures of the replication conduit 158, as indicated by arrow 160. The snooper thread returns the scan buffer containing the scan block 146 to the empty list 106, as indicated by arrow 161, so that the scan buffer can be reused.

In one or more computer systems 162 and 164, the apply component, Apply 1 166 and Apply n 168, receives the rows of the scan block in the replication conduit and applies those rows to one or more target tables, Target table 1 172 and Target table n 174, respectively.

The row data in the scan blocks is typically sent in the same replication conduit as the replication data from on-going replication to avoid out-of-order issues in the target table. The ordering of the replication data of on-going replication is determined by the order in which the rows are committed. The ordering of the synchronization data is determined based on the commit that is associated with the token that is associated with the rows of synchronization data of the scan block. Commit operations on the tokens that are associated with synchronization data are interspersed concurrent with commit operations that are associated with user activity at the source server. The replication data as well as synchronization data are placed in the same replication conduit in commit order. In some embodiments, the snooper places the synchronization data, which comprises the rows of a scan block, into a data structure of the grouper 42 (FIG. 2); alternately, the rows are placed into a data structure of the replication conduit which is accessible to the grouper 42 (FIG. 2). The grouper 42 (FIG. 2) places the replication and synchronization data into the queue 44 (FIG. 2) in accordance with the commit order of the replication and synchronization data. The apply component at a target server receives replication and synchronization data from the queue 52 (FIG. 2) in the same order as the data is placed into the queue.

A user typically initiates a synchronization of a target table using a synchronization command. The exemplary synchronization commands specify a replicate, a source server and at least one target server. The specified replicate is typically a primary replicate, of which the source server and the target server(s) are participants. The specified replicate may have other participants in addition to the specified source and target servers.

In various embodiments, the scanner makes use of a shadow replicate. A shadow replicate is a replicate which is defined to be used in conjunction with another replicate, that is, the primary replicate. The shadow replicate can have one or more differences from the primary replicate. For instance, the shadow replicate may have different columns from the primary replicate, or may involve only a subset of the participants of the primary replicate. Also, the shadow replicate may have different conflict resolution rules from the primary replicate. In synchronization, the shadow replicate comprises a subset of the participants of the primary replicate. In some embodiments, the subset of the participants comprises less than all participants of the primary replicate; in other embodiments, the subset of the participants comprises all the participants of the primary replicate. The apply component at the replication target server, considers the shadow and primary replicates as equivalent, and applies replication and synchronization data for the primary and shadow replicates to the target table as though the primary and shadow replicates are a single replicate. One or more shadow replicates may be associated with a single primary replicate.

Generally during replication a source server transmits replication data using the primary replicate. When synchronizing a target table, a shadow replicate is created and the synchronization data is replicated from the source table to the target table using the shadow replicate. In various embodiments, for the purpose of synchronizing a table, the shadow replicate has one source server, and one or more target servers as participants. Using the shadow replicate prevents the synchronization data from being replicated to any participants of the primary replicate that are not being synchronized. In addition, the shadow replication helps to distinguish between synchronization data and replication data.

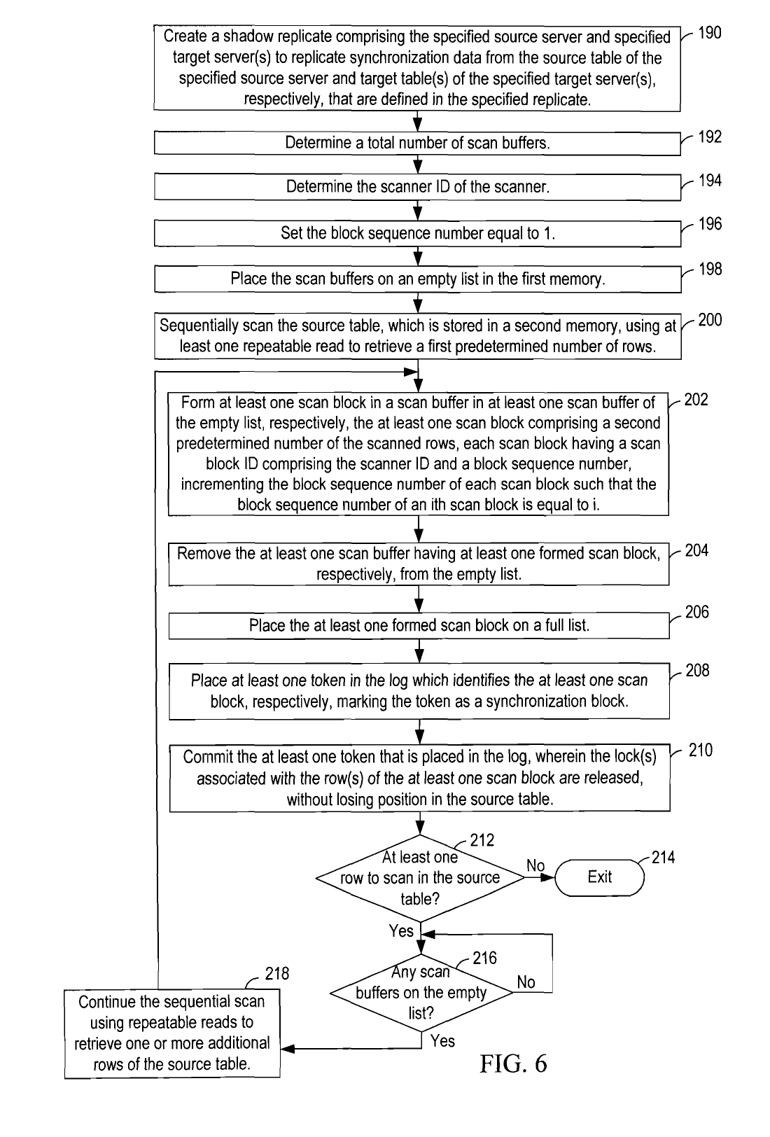

FIG. 6 depicts a flowchart of an embodiment of the scanner of the present invention. In various embodiments, the scanner is executed in response to receiving a synchronization command. The replicate name, source server and target server(s) are specified in the synchronization command.

In step 190, the scanner creates a shadow replicate comprising the specified source server and specified target server(s) to replicate synchronization data from the source table of the specified source server and target table(s) of the specified target server(s), respectively, that are defined in the specified replicate. The scanner retrieves information describing the source and target tables from the replicate definition of the specified replicate and uses that information to create the shadow replicate. Conflict resolution is part of the replicate definition. In some embodiments, replication uses timestamp conflict resolution, and in other embodiments, stored procedure conflict resolution. In timestamp conflict resolution, the row with the most recent timestamp is applied. For example, the primary replicate may be flagged to use timestamp conflict resolution. In various embodiments, the shadow replicate is flagged as always apply. Flagging the shadow replicate as always apply causes the rows that are replicated using the shadow replicate to be applied regardless of the conflict resolution rules.

In step 192, the scanner determines a total number of scan buffers. The scan blocks are stored in a first memory. For example, the first memory is typically semiconductor or solid-state memory. A scan buffer contains a scan block. A scan buffer is typically the same size as a scan block. In some embodiments, the scanner also determines a number of rows of the source table that are to be stored in a the scan block. The scanner calculates the total number of scan buffers and the number of rows that are to be stored in the scan blocks based on the row size of the source table, the total available memory for replication, and in some embodiments, some considerations to encourage parallelism by the apply component at the target server(s). Alternately, the number of rows that are to be stored in a scan block is predetermined. For example, the total number of scan buffers may be equal to ten while the synchronization data of a source table may use forty scan blocks. Therefore the scanner manages the scan buffers and scan blocks.

In step 194, the scanner determines its scanner ID. In some embodiments, the scanner ID is a thread identifier, in other embodiments, the scanner ID is a process identifier.

In step 196, the scanner sets the block sequence number equal to one.

In step 198, the scanner places the scan buffers on an empty list in the first memory.

In step 200, the scanner sequentially scans the source table, which is stored in a second memory, using at least one repeatable read to retrieve a first predetermined number of rows. The repeatable read causes the rows of the table that are scanned to be locked. The scanner scans the source table within a series of transactions using repeatable reads to provide consistency. In other embodiments, more generally, the rows are scanned using a read that locks the rows. The second memory is typically persistent storage, for example, a disk. The rows of the table are stored on physical pages in the persistent storage, and the physical pages are ordered. The scanner retrieves the rows from the first physical page of the table, and continues to retrieve rows from consecutive physical pages of the table. Therefore, the rows are retrieved in the order in which they are physically stored, rather than in logical order.

In step 202, the scanner forms at least one scan block in at least one of the scan buffers of the empty list, respectively. The at least one scan block comprises a second predetermined number of the scanned rows. Rows are placed in the scan blocks in accordance with the physical order of the rows on the physical pages. Each scan block has a scan block ID comprising the scanner ID and a block sequence number, the block sequence number of each scan block is incremented such that the block sequence number of an i^{th} scan block is equal to i. The rows of a scan block will be propagated to the target server(s) as a transactional unit using the shadow replicate. The scan blocks are stored in the first memory, and the first memory typically has a higher speed than the second memory. In some embodiments, the first predetermined number of rows of step 200 is equal to the second predetermined number of rows of step 202. In other embodiments, the first predetermined number of rows of step 200 is greater than the second predetermined number of rows of step 202.

In step 204, the scanner removes the at least one scan buffer having at least one formed scan block, respectively, from the empty list. In step 206, the scanner places the at least one formed scan block on a full list. The full list is typically stored in the first memory.

In step 208, the scanner places at least one token in the log which identifies the at least one scan block, respectively, marking the token as a synchronization block. For example, in some embodiments, a log record comprising the token is placed into the log and the log record has a flag which, when set, marks the token as a synchronization block. In various embodiments, the token comprises the scan block ID. In other embodiments, the token is the scan block ID.

In step 210, the scanner commits the at least one token that is placed in the log, wherein the lock(s) associated with the row(s) of the at least one scan block that is associated with the at least one token, respectively, are released, without losing position in the source table.

In step 212, the scanner determines whether there is at least one row to scan in the source table. If not, in step 214, the scanner exits. If in step 212, the scanner determines that there is at least one row to scan, in step 216, the scanner determines whether there are any scan buffers on the empty list. If not, the scanner proceeds back to step 216 to wait for a scan buffer to become available on the empty list.

In response to the scanner determining in step 216, that there is a scan buffer on the empty list, in step 218, the scanner continues the sequential scan using repeatable reads to retrieve one or more additional rows of the source table. Step 218 proceeds to step 202.

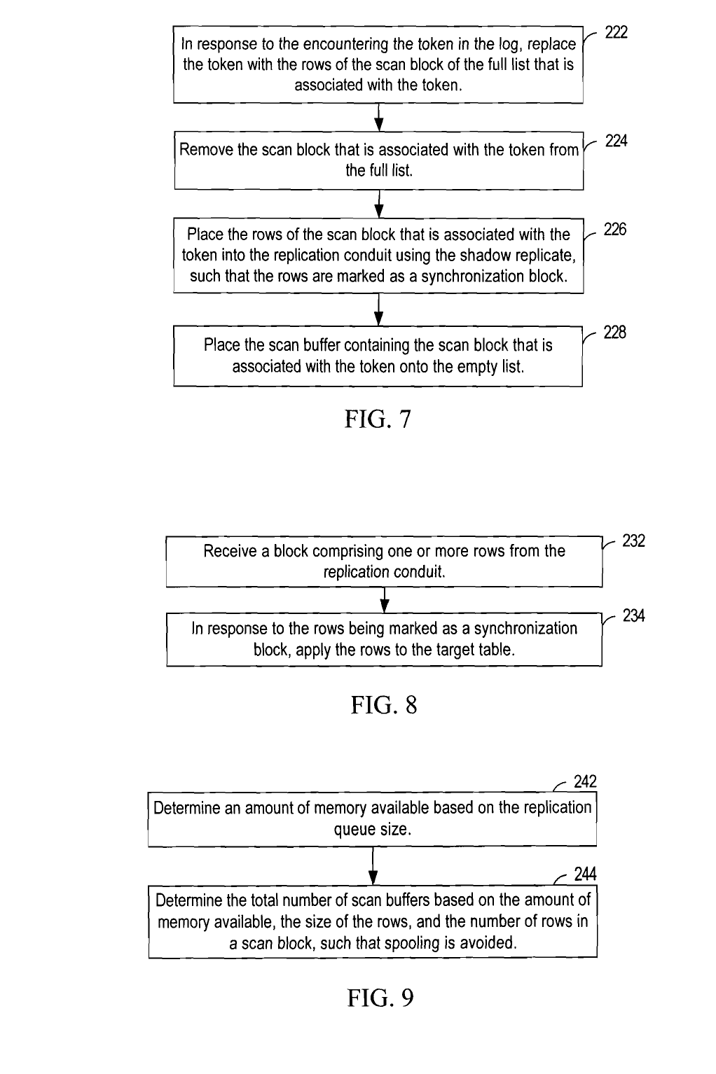

FIG. 7 depicts a flowchart of an embodiment of the snooper of the present invention. In step 222, in response to the encountering a token, the snooper replaces the token with the rows of the scan block of the full list that is associated with the token.

In step 224, the snooper removes the scan block that is associated with the token from the full list.

In step 226, the snooper places the rows of the scan block that is associated with the token into the replication conduit using the shadow replicate, such that the rows are marked as a synchronization block. The rows of the scan block are also associated with the commit that is associated with the token. In various embodiments, the token contains the scan block ID, and the scanner searches the full list for the scan block that contains the scan block ID of the token. In various embodiments, the snooper places the rows of the scan block into a data structure of the replication conduit at the location that is associated with the token. The data structure may be associated with the grouper, or may be associated with another module of the replication conduit depending on the embodiment. Once in the replication conduit, conventional replication techniques are used to propagate the rows.

In step 228, the snooper places the scan buffer containing the scan block that is associated with the token onto the empty list.

FIG. 8 depicts a flowchart of an embodiment of the apply component at a target server computer. In step 232, a block comprising one or more rows is received from the replication conduit. In step 234, in response to the rows being marked as a synchronization block, the apply component applies the rows to the target table. In various embodiments, the apply component performs an insert, update or delete of rows to the target table such that the data of the target table matches the data of the source table as of the commit that is associated with the token that is associated with the rows that are received.

In various embodiments, the present invention synchronizes a table quickly, and reduces the overhead of logging by using a token to represent a block of rows.

In some embodiments, the token is placed into the log using buffered logging to help to reduce the number of log flushes while scanning the source table.

FIG. 9 depicts a flowchart of an embodiment of determining a total number of scan buffers of step 192 of FIG. 6. In step 232, the scanner determines the amount of memory available based on the replication queue size. In various embodiments, the scanner determines an amount of first memory available based on the replication queue size. In step 234, the scanner determines the total number of scan buffers based on an amount of memory available for replication, the size of the rows of the source table, and the number of rows in a scan block, such that spooling is avoided.

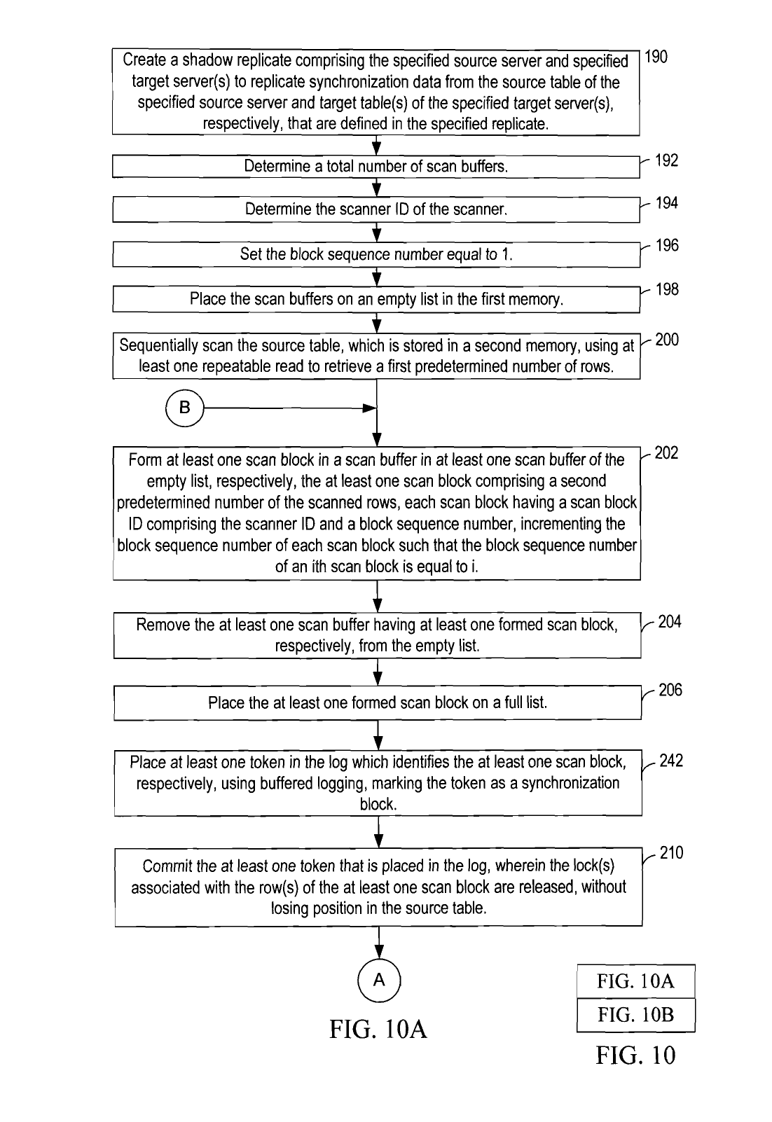

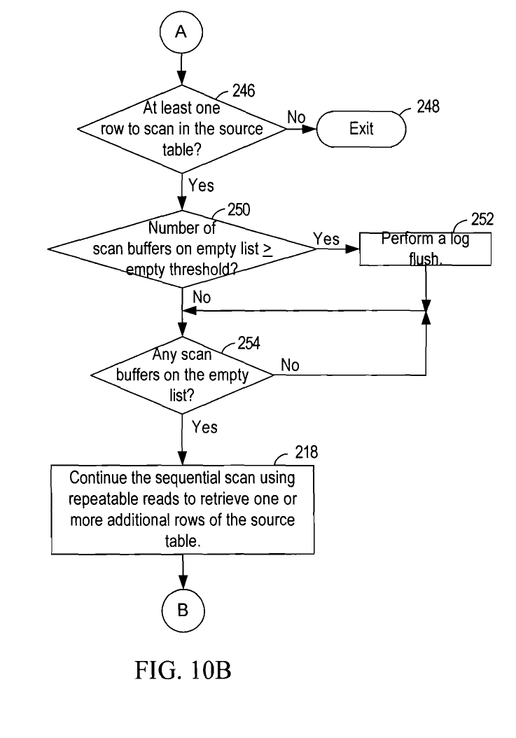

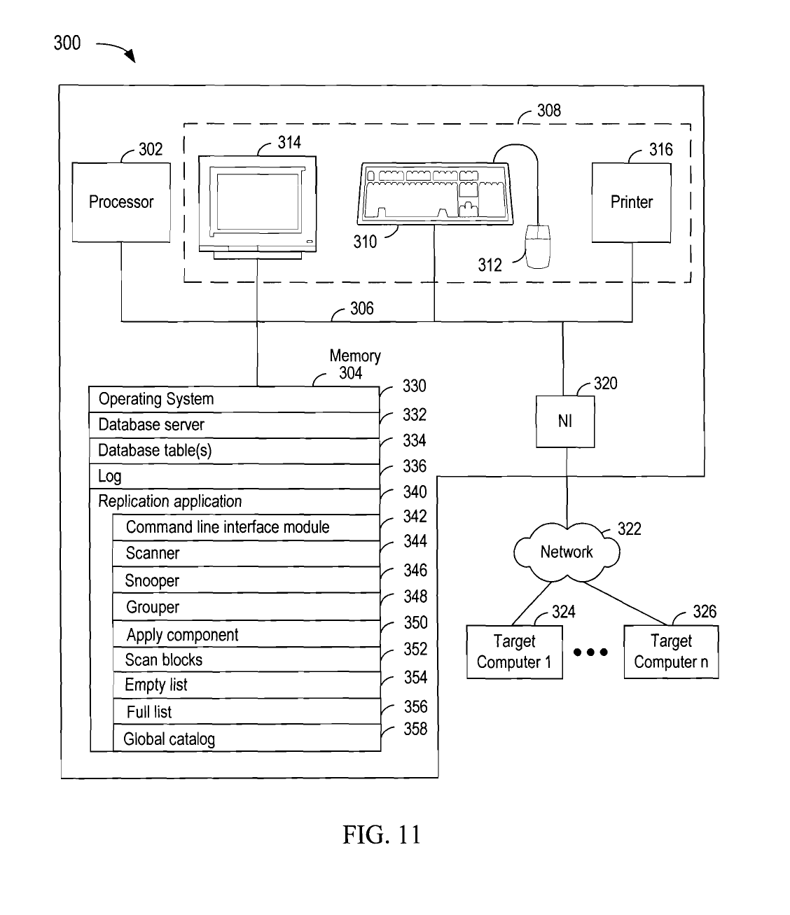

FIG. 10 comprises FIGS. 10A and 10B which collectively depict a flowchart of another embodiment of the scanner in which buffered logging is used. Steps 190-206 and 210 of the flowchart of FIG. 10A are the same as in the flowchart of FIG. 6 and will not be further described. In step 242, the scanner places at least one token in the log which identifies the at least one scan block, respectively, using buffered logging, marking the token as a synchronization block. Step 242 proceeds to step 210, and step 210 proceeds via Continuator A to step 246 of FIG. 10B.

In step 246 of FIG. 10B, the scanner determines whether there is at least one row to scan in the source table. If not, in step 248, the scanner exits.

In response to step 246 determining that there is at least one row to scan in the source table, in step 250, the scanner determines whether the number of scan buffers on the empty list is greater than or equal to an empty threshold. In some embodiments, the empty threshold has a value equal to one half of the total number of scan buffers. In other embodiments, the empty threshold has a different value.

In response to step 250 determining that the number of scan buffers on the empty list is greater than or equal to the empty threshold, in step 252, the scanner causes a log flush to be performed and proceeds to step 254. The log flush causes any log pages containing a token that are written to the log prior to the flush to be available to the snooper to process.

In response to the scanner determining that the number of scan buffers on the empty list is not greater than or equal to the empty threshold, the scanner proceeds to step 254.

In step 254, the scanner determines whether there are any scan buffers on the empty list. If not, the scanner proceeds back to step 254 to wait for a scan buffer to become available. In response to, in step 254, the scanner determining that there is at least one scan buffer on the empty list, the scanner proceeds to step 218, and step 218 proceeds via Continuator B to step 202 of FIG. 10A.

In another embodiment, a row may be associated with a binary large object. The row that has the binary large object contains a locator having the location of the binary large object, and does not physically store the binary large object content in the row. If a binary large object is updated after scanning the row, the location of the binary large object in the locator in the row of the scan block may no longer be valid. If the row of the scan block references a binary large object and the location of the binary large object is not valid, the snooper replicates the row, marking the locator as being changed. Because the binary large object is updated by a transactional event, that transactional event is recorded in the log subsequent to the token. Therefore, in this case, the binary large object is replicated after the rows of the scan block as the subsequent transaction event that updated the binary large object is replicated.

Various embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, various embodiments of the invention can take the form of a computer program product accessible from a computer usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital video disk (DVD).

FIG. 11 depicts an illustrative data processing system 300 which uses various embodiments of the present invention. The data processing system 300 suitable for storing and/or executing program code will include at least one processor 302 coupled directly or indirectly to memory elements 304 through a system bus 306. The memory elements 304 can include local memory employed during actual execution of the program code, bulk storage, and cache memories which provide temporary storage of at least some program code in order to reduce the number of times code must be retrieved from bulk storage during execution.

Input/output or I/O devices 308 (including but not limited to, for example, a keyboard 310, pointing device such as a mouse 312, a display 314, printer 316, etc.) can be coupled to the system bus 306 either directly or through intervening I/O controllers.

Network adapters, such as a network interface (NI) 320, may also be coupled to the system bus 306 to enable the data processing system to become coupled to other data processing systems or remote printers or storage devices through intervening private or public networks 322. Modems, cable modem and Ethernet cards are just a few of the currently available types of network adapters. The network adapter may be coupled to the network via a network transmission line, for example twisted pair, coaxial cable or fiber optic cable, or a wireless interface that uses a wireless transmission medium. In addition, the software in which various embodiments are implemented may be accessible through the transmission medium, for example, from a server over the network.

The network 322 is typically coupled to one or more target computer systems, Target Computer 1 to Target Computer n, 324 and 326, respectively.

The memory elements 304 store an operating system 330, database server 332, database tables 334, log 336, and replication application 340. The replication application 340 comprises a command line interface module 342, a scanner 344, a snooper 346, a grouper 348, an apply component 350, scan blocks 352, an empty list 354 a full list 356, and a global catalog 358.

The operating system 330 may be implemented by any conventional operating system such as z/OS® (Registered Trademark of International Business Machines Corporation), MVS® (Registered Trademark of International Business Machines Corporation), OS/390® (Registered Trademark of International Business Machines Corporation), AIX® (Registered Trademark of International Business Machines Corporation), UNIX® (UNIX is a registered trademark of the Open Group in the United States and other countries), WINDOWS® (Registered Trademark of Microsoft Corporation), LINUX® (Registered trademark of Linus Torvalds), Solaris® (Registered trademark of Sun Microsystems Inc.) and HP-UX® (Registered trademark of Hewlett-Packard Development Company, L.P.).

The exemplary data processing system 300 that is illustrated in FIG. 11 is not intended to limit the present invention. Other alternative hardware environments may be used without departing from the scope of the present invention.

The network 322 is coupled to one or more target computer systems, Target Computer 1 to Target Computer n, 324 and 326, respectively.

In various embodiments, the database server 332 is the IBM® (Registered Trademark of International Business Machines Corporation) Informix® (Registered Trademark of International Business Machines Corporation) Dynamic Server. However, the invention is not meant to be limited to the IBM Informix Dynamic Server and may be used with other database management systems.

The exemplary computer system illustrated in FIG. 11 is not intended to limit the present invention. Other alternative hardware environments may be used without departing from the scope of the present invention.

The foregoing detailed description of various embodiments of the invention has been presented for the purposes of illustration and description. It is not intended to be exhaustive or to limit the invention to the precise form disclosed. Many modifications and variations are possible in light of the above teachings. It is intended that the scope of the invention be limited not by this detailed description, but rather by the claims appended thereto.

What is claimed is:

1. A computer-implemented method comprising:
scanning rows of a source table of a database, said source table comprising a plurality of rows, wherein said rows that are scanned are locked with at least one lock;
forming at least one scan block comprising at least one row of said rows of said source table;
placing at least one token that is associated with said at least one scan block, respectively, in a log;
releasing said at least one lock that is associated with said at least one row that is associated with said at least one token; and
in response to encountering one token of said at least one token in said log, placing said at least one row of said scan block that is associated with said one token in a replication conduit.

2. The method of claim 1 further comprising:
receiving said at least one row of said scan block that is associated with said one token in said replication conduit; and
applying said at least one row of said scan block that is associated with said one token to a target table.

3. The method of claim 1 wherein said token comprises a scan block identifier comprising a scanner identifier and a block sequence number, said scanner identifier having a value that is associated with a software module performing said scanning, and said block sequence number being associated with an order of said forming said at least one scan block.

4. The method of claim 1 wherein said scanning uses repeatable reads.

5. The method of claim 1 further comprising:
determining a total number of scan buffers based on a size of said rows of said source table, a size of a replication queue of said replication conduit and an amount of memory, the scan buffers being used to store said at least one scan block.

6. The method of claim 1 wherein said locks are released in response to a commit.

7. The method of claim 1 further comprising:
in response to one row of said at least one row of said at least one scan block comprising a locator having an invalid location of a binary large object, marking said locator as being changed.

8. The method of claim 1 wherein said scanning scans said rows of said source table in accordance with a physical location of pages containing said rows in a persistent memory.

9. The method of claim 1 wherein said at least one scan block is stored in a first type of memory and said source table is stored in a second type of memory different from said first type of memory.

10. The method of claim 1 wherein said placing said at least one token uses buffered logging, further comprising:
in response to a number of empty scan blocks exceeding an empty threshold, flushing said log.

11. A computer program product comprising a computer usable medium having computer usable program code for synchronizing a table, said computer program product including:
computer usable program code for scanning rows of a source table of a database, said source table comprising a plurality of rows, wherein said rows that are scanned are locked with at least one lock;
computer usable program code for forming at least one scan block comprising a predetermined number of said rows of said source table;
computer usable program code for placing at least one token that is associated with said at least one scan block, respectively, in a log;
computer usable program code for releasing said at least one lock that is associated with said rows that are associated with said at least one token; and
computer usable program code for, in response to encountering one token of said at least one token in said log, placing said rows of said scan block that is associated with said one token in a replication conduit.

12. The computer program product of claim 11 further comprising:
computer usable program code for receiving said rows of said one scan block that is associated with said one token in said replication conduit; and
computer usable program code for applying said rows of said scan block that is associated with said one token to a target table.

13. The computer program product of claim 11 wherein said computer usable program code for scanning uses repeatable reads.

14. The computer program product of claim 11 further comprising:
computer usable program code for determining a total number of scan buffers based on a size of said rows of said source table, a size of a replication queue of said replication conduit, and an amount of memory that is available for replication, the scan buffers being used to store said at least one scan block.

15. The computer program product of claim 11, further comprising:
wherein said at least one scan block is formed in a first type of memory, and
wherein said computer usable program code for scanning scans said rows of said source table in accordance with a physical location of pages containing said rows in a second type of memory different from said first type of memory.

16. A data processing system comprising:
a processor; and
a memory storing instructions to be executed by said processor, said memory comprising a first type of memory and a second type of memory different from said first type of memory, said second type of memory storing a source table of a database, said source table comprising a plurality of rows, said memory storing instructions that:
scan rows of said source table, wherein said rows that are scanned are locked with at least one lock;
form at least one scan block comprising at least one row of said rows of said source table in said first type of memory;
place at least one token that is associated with said at least one scan block, respectively, in a log;
release said at least one lock that is associated with said at least one row that are associated with said at least one token; and
in response to encountering one token of said at least one token in said log, place said at least one row of said scan block that is associated with said one token into a replication conduit.

17. The data processing system of claim 16 wherein said one or more instructions that scan uses repeatable reads.

18. The data processing system of claim 16 further comprising:
one or more instructions that determine a total number of said scan buffers based on a size of said rows of said source table, a size of a replication queue of said replication conduit and an amount of said second type of memory that is available for replication, such that spooling is avoided, the scan buffers being used to store said at least one scan block.

19. The data processing system of claim 16 wherein said one or more instructions scans said rows of said source table based on a physical location of pages of said second type of memory containing said rows.

20. The data processing system of claim 16 wherein said one or more instructions that place said at least one token uses buffered logging, said memory also storing:
one or more instructions that, in response to a number of empty scan buffers exceeding an empty threshold, cause said log to be flushed.
